(19) United States
(12) Patent Application Publication
(10) Pub. No.: US 2018/0120888 A1
(43) Pub. Date: May 3, 2018

(54) INTERCHANGEABLE JOYSTICK AND THROTTLE

(71) Applicants: Jacob Meuzelaar, Cromwell, IN (US); Thomas Meuzelaar, Cromwell, IN (US)

(72) Inventors: Jacob Meuzelaar, Cromwell, IN (US); Thomas Meuzelaar, Cromwell, IN (US)

(21) Appl. No.: 15/340,462

(22) Filed: Nov. 1, 2016

(51) Int. Cl. G05G 9/047; G05G 1/04; G06F 3/0338; G06F 3/041; A63F 13/2145; A63F 13/24

(52) U.S. Cl. CPC G05G 9/047; G05G 1/04; G06F 3/0338; G05G 2009/04774; A63F 13/2145; A63F 13/24; G06F 3/041

(57) ABSTRACT

A interchangeable joystick assembly that includes: a base; a joystick that extends from the base, wherein said joystick is connected to the base through a swivel connector; an opening at the center of the base adapted to receive the swivel connector; a touch screen on the base; and a plurality of controls adapted for interchangeable use. The plurality of controls may include control buttons and a trigger. Preferably, the control buttons are adapted on one side of the joystick

### BACKGROUND OF THE INVENTION

### Field of Invention

The present invention relates to an interchangeable joystick with accompanying throttle.

### Description of Related Art

Many gamers use joysticks to control their interactive gaming activity. The joystick is usually used to simulate navigational games related to planes, ships and other similar related gaming environments. A joystick may also be used to simulate space travel and typically includes various control buttons and a trigger. One drawback to the typical joystick is that it is configured for a right handed individual. Left handed individuals have limited options with respect to adaptation of a joystick for their needs. As a result, it would be advantageous to have an interchangeable joystick and throttle that could be implemented for gaming purposes.

### SUMMARY OF THE INVENTION

The present invention relates to an interchangeable joystick assembly that includes: a base; a joystick that extends from the base, wherein said joystick is connected to the base through a swivel connector; an opening at the center of the base adapted to receive the swivel connector; a touch screen on the base; and a plurality of controls adapted for interchangeable use. The plurality of controls may include control buttons and a trigger. Preferably, the control buttons are adapted on one side of the joystick

### BRIEF DESCRIPTION OF DRAWINGS

FIG. 1 depicts an interchangeable joystick in accordance with the present invention.

FIG. 2 depicts an interchangeable throttle for gaming purposes.

### DETAILED DESCRIPTION

The present invention relates to an interchangeable joystick and throttle adapted for use for either left handed or right handed individuals. The interchangeable joystick and throttle include appropriate control buttons for interactivity and are configured onto the joystick for the user.

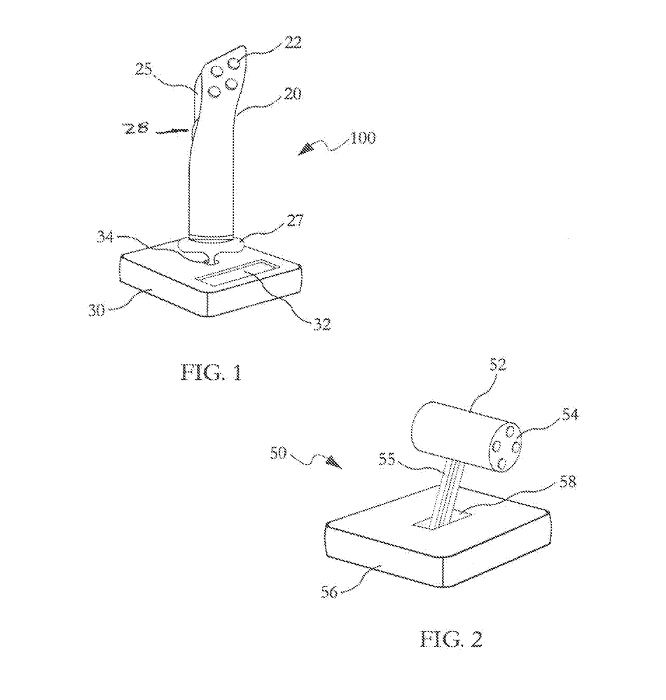

FIG. 1 depicts an interchangeable joystick assembly 100 in accordance with the present invention. This joystick assembly 100 includes a joystick 20 that extends from a base 30. The joystick 20 is connected to the base 30 through a swivel connector 27 and is inserted into opening 34 at the center of the base 30. Also at the base 30 is a touch screen 32, which can provide feedback and interactive information for the user. While engaging in an interactive game a user may typically have team mates based upon the game configuration. The touch screen 32 enables a user to engage in communications with other team mates in order to plan and verify in game strategy. Preferably icons may be shown on the touch screen 32 to engage in the communications. Other features of joystick 20 include control buttons 22 and trigger 25. The control buttons 22 are adapted on one side of the joystick and further trigger 25 includes a thumb contact point 28.

The joystick assembly 100 may be used in conjunction with a throttle 50 as shown in FIG. 2. Throttle 50 includes hand grip 52, which is substantially cylindrical and mounted on a stem 55. Control buttons 54 are provided on a thumb side of the hand grip 52. Stem 55 extends from a base 56 through opening 53. A user may function and operate the throttle 50 in conjunction with interactive gaming as desired. Control mechanisms are available through control buttons 54. The interchangeable control accessories may easily be implemented and configured for gaming enjoyments so that the joystick and throttle may be used by both left-handed and right-handed individuals.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An interchangeable joystick assembly for interactive team gaming comprising:
a. a base;
b. a joystick that extends from the base, wherein said joystick is connected to the base through a swivel connector;
c. an opening at the center of the base adapted to receive the swivel connector;
d. a touch screen on the base, wherein the touch screen enables communications between a user and other team mates; and
e. a plurality of controls adapted for interchangeable use.

2. The interchangeable joystick assembly according to claim 1, where the plurality of controls includes control buttons and a trigger.

3. The interchangeable joystick assembly according to claim 1, where the control buttons are adapted on one side of the joystick.

4. The interchangeable joystick assembly according to claim 1, where the trigger includes a thumb contact point.

5. (canceled)

6. A system for interactive gaming control comprising:
a. a joystick assembly wherein said joystick assembly includes:
i. a base;
ii. a joystick that extends from the base, wherein said joystick is connected to the base through a swivel connector;
iii. an opening at the center of the base adapted to receive the swivel connector;
iv. a touch screen on the base, wherein the touch screen enables communications between a user and other team mates; and
v. a plurality of controls adapted for interchangeable use; and
b. an interchangeable throttle controller that includes:
i. a throttle adapted for interchangeable use where said throttle includes a hand grip, which is substantially cylindrical;
ii. a stem, where said stem supports the hand grip;
iii. a plurality of control buttons on a thumb side of the hand grip; and
iv. a base, where the base includes an opening and said stem extends from the opening.
